(19) United States
(12) Patent Application Publication
(10) Pub. No.: US 2024/0253368 A1
(43) Pub. Date: Aug. 1, 2024

(54) RECORDING APPARATUS

(71) Applicant: CANON KABUSHIKI KAISHA, Tokyo (JP)

(72) Inventors: MASAHIRO SUGIMOTO, Kanagawa (JP); JUNICHI OCHI, Shizuoka (JP); TAKUMA NAKAMURA, Tokyo (JP); YUICHIRO YANAGI, Chiba (JP)

(21) Appl. No.: 18/417,430

(22) Filed: Jan. 19, 2024

(30) Foreign Application Priority Data
Jan. 27, 2023 (JP) 2023-011019

(51) Int. Cl. B41J 11/00

(52) U.S. Cl. CPC B41J 11/0095; B41J 11/007

(57) ABSTRACT

A recording apparatus includes: a first rotating member, a second rotating member that is adjacent to and downstream of the first rotating member, a third rotating member positioned downstream of the second rotating member, a recording portion, and a floating detection portion. As viewed along a rotation axis line direction of the first rotating member, letting a first arc portion be an abutment portion between the recording medium and the first rotating member, and letting a third arc portion be an abutment portion between the recording medium and the third rotating member, a third arc height, which is a distance from a chord of the third arc portion to an apex of the third arc portion, is smaller than a first arc height, which is a distance from a chord of the first arc portion to an apex of the first arc portion.

### BACKGROUND OF THE INVENTION

### Field of the Invention

The present invention relates to a recording apparatus.

### Description of the Related Art

Conventionally, inkjet recording apparatuses and the like are known as recording apparatuses that record text, images, and the like by discharging ink onto a recording medium, which is in the form of a continuous sheet and is wound as a roll. One type of inkjet recording apparatus is a line head recording apparatus that records text and images onto a recording medium by discharging droplets from recording heads in conjunction with conveyance of the recording medium, without the recording heads moving relative to the main body of the apparatus in the conveying direction of the recording medium.

If a recording medium unintentionally floats or is curled during a recording operation, there is a risk that the recording medium will come into contact with a recording head, leading to damage to the recording head. Japanese Patent Application No. 2021-66130 discloses a configuration of a recording apparatus that includes a floating detection portion for detecting a floating amount of a recording medium at a position upstream of a recording portion, which performs a recording operation, in the conveying direction.

### SUMMARY OF THE INVENTION

However, in a configuration in which a guide roller for guiding conveyance of a recording medium is provided between a recording portion and a floating detection portion, there is a risk that the recording medium will float after moving through the floating detection portion and enter the recording portion in a state where the recording medium is floating.

The present invention has been made in view of the foregoing issue, and an object of the present invention is to provide a recording apparatus that suppresses damage to a recording head.

In order to achieve the aforementioned object, a recording apparatus according to the present invention includes:
a first rotating member for supporting a recording medium while rotating, and conveying the recording medium along an outer peripheral surface of the first rotating member such that a recording side of the recording medium bulges;
a second rotating member that is adjacent to and downstream of the first rotating member in a conveying direction of the recording medium, the second rotating member being for supporting the recording medium while rotating;
a third rotating member downstream of the second rotating member in the conveying direction, the third rotating member being for supporting the recording medium while rotating, and conveying the recording medium along an outer peripheral surface of the third rotating member such that the recording side of the recording medium bulges;
a recording portion for performing a recording operation on the recording side of the recording medium, at a location downstream of the third rotating member in the conveying direction; and
a floating detection portion for detecting floating of the recording medium between the first rotating member and the second rotating member,
wherein, as viewed along a rotation axis line direction of the first rotating member, letting a first arc portion be an abutment portion between the recording medium and the first rotating member, and letting a third arc portion be an abutment portion between the recording medium and the third rotating member, a third arc height, which is a distance from a chord of the third arc portion to an apex of the third arc portion, is smaller than a first arc height, which is a distance from a chord of the first arc portion to an apex of the first arc portion.

In order to achieve the aforementioned object, a recording apparatus according to the present invention includes:
a first rotating member for supporting a recording medium while rotating, and conveying the recording medium along an outer peripheral surface of the first rotating member such that a recording side of the recording medium bulges;
a second rotating member that is adjacent to and downstream of the first rotating member in a conveying direction of the recording medium, the second rotating member being for supporting the recording medium while rotating;
a third rotating member downstream of the second rotating member in the conveying direction, the third rotating member being for supporting the recording medium while rotating, and conveying the recording medium along an outer peripheral surface of the third rotating member such that the recording side of the recording medium bulges;
a recording portion for performing a recording operation on the recording side of the recording medium, at a location downstream of the third rotating member in the conveying direction; and
a floating detection portion for detecting floating of the recording medium between the first rotating member and the second rotating member,
wherein, as viewed along a rotation axis line direction of the first rotating member, letting a first arc portion be an abutment portion between the recording medium and the first rotating member, and letting a third arc portion be an abutment portion between the recording medium and the third rotating member, a central angle of the third arc portion is smaller than a central angle of the first arc portion.

According to the present invention, it is possible to provide a recording apparatus that suppresses damage to a recording head.

Further features of the present invention will become apparent from the following description of exemplary embodiments with reference to the attached drawings.

### BRIEF DESCRIPTION OF THE DRAWINGS

FIG. 1 is a schematic diagram showing an internal configuration of a recording apparatus according to a first embodiment;

FIG. 2 is a perspective view of a conveyance portion case of a recording portion according to the first embodiment;

FIG. 3 is a perspective view of a lifting and lowering mechanism of a recording head according to the first embodiment;

FIG. 4 is a schematic diagram showing a conveyance path from a detection portion to the recording portion according to the first embodiment;

FIG. 5 is a schematic diagram showing a sheet conveyance state in the recording portion according to the first embodiment;

FIGS. 6A and 6B are schematic diagrams showing a sheet state under tension overload according to the first embodiment;

FIG. 7 is a schematic cross-sectional view showing a sheet conveyance state in the detection portion according to the first embodiment;

FIG. 8 is a diagram illustrating a sensor output waveform of a floating detection unit according to the first embodiment;

FIGS. 9A and 9B are diagrams illustrating a label roll subjected to waste removing processing;

FIGS. 10A and 10B are diagrams illustrating label peeling of a label roll;

FIG. 11 is a diagram illustrating a camber of a label roll when the label roll is moving past a guide roller;

FIG. 12 is a schematic diagram showing a conveyance path from the detection portion to the recording portion;

FIG. 13 is a block diagram of a control system of the recording apparatus according to the first embodiment;

FIG. 14 is a control flowchart of the floating detection portion according to the first embodiment; and

FIG. 15 is a schematic diagram showing a conveyance path from a detection portion to a recording portion according to a second embodiment.

### DESCRIPTION OF THE EMBODIMENTS

Modes for carrying out the invention will be illustratively described below in detail based on embodiments with reference to the drawings. Note that the sizes, materials, shapes, relative arrangement, and the like of constituent components described in the embodiments are to be changed as appropriate based on various conditions and a configuration of an apparatus to which the invention is applied. That is to say, the scope of the invention is not intended to be limited to the following embodiments.

### First Embodiment

### Recording Apparatus 1

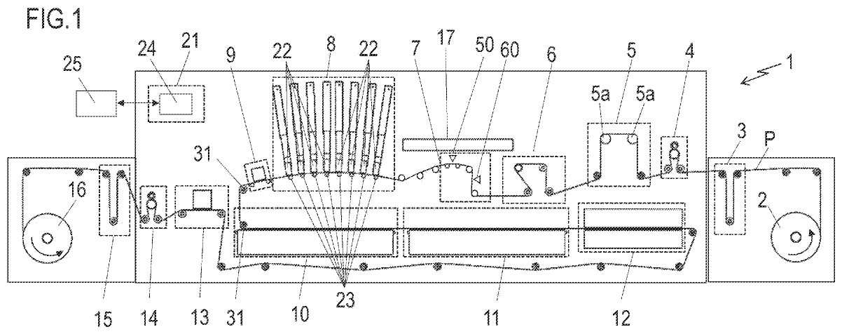

First, a schematic configuration of a recording apparatus 1 according to a first embodiment will be described. FIG. 1 is a schematic cross-sectional view showing an internal configuration of the recording apparatus 1. The recording apparatus 1 includes units such as an unwinding roll portion 2, a first dancer portion 3, a first main conveyance portion 4, a meandering correction portion 5, a conveyance detection portion 6, a detection portion 7, a recording portion 8, a first scanner portion 9, a first drying portion 10, a second drying portion 11, and a cooling portion 12. Furthermore, the recording apparatus 1 also includes units such as a second scanner portion 13, a second main conveyance portion 14, a second dancer portion 15, a winding roll portion 16, and a maintenance portion 17. A sheet S is conveyed along a conveyance path P for the sheet S indicated by the solid line in FIG. 1, and is subjected to processing performed by the units.

The unwinding roll portion 2 is a unit for holding and supplying a continuous sheet wound as a role. The unwinding roll portion 2 is configured to accommodate an unwinding roll, draw the sheet S out from the unwinding roll, and supply the sheet S. Note that the number of rolls that can be accommodated is not limited to one, and the unwinding roll portion 2 may also be configured to accommodate two rolls or three or more rolls, and alternatively draw and supply the sheet S.

The first dancer portion 3 is a unit for applying a certain tension to the sheet S between the unwinding roll portion 2 and the first main conveyance portion 4. In the first dancer portion 3, a tension is applied to the sheet S by a tension providing means (not illustrated).

The first main conveyance portion 4 is a unit for conveying the sheet S, and applying a tension to the sheet S between the first main conveyance portion 4 and the second main conveyance portion 14. Due to the first main conveyance portion 4, the sheet S is fed to the meandering correction portion 5, the conveyance detection portion 6, the detection portion 7, the recording portion 8, the first scanner portion 9, the first drying portion 10, the second drying portion 11, the cooling portion 12, and the second scanner portion 13 arranged along the conveyance path P of the sheet S, in the stated order.

The conveyance path for the sheet S is constituted by the units, guide rollers provided between the units, and the like, and the sheet S is conveyed along the conveyance path P while being guided by a plurality of guide rollers. In addition, the conveyance path P is a path that is roughly formed by connecting the circumferential surfaces of a plurality of rollers and tangent lines of adjacent rollers, and on which the sheet S moves in the recording apparatus 1.

The first main conveyance portion 4 includes rollers that are rotated by driving a motor (not illustrated), and conveys the sheet S while applying a tension to the sheet S using the rollers. In the first embodiment, the sheet S is conveyed along the conveyance path P in a state where a tension is applied to the sheet S by the first main conveyance portion 4 and the second main conveyance portion 14 to be described later.

The meandering correction portion 5 is a unit for correcting meandering of the sheet S when the sheet S is being conveyed. The meandering correction portion 5 includes meandering correction rollers 5a and a meandering detection sensor (not illustrated) for detecting meandering of the sheet S. The meandering correction rollers 5a are capable of changing inclination of the sheet S by a motor (not illustrated), and correct meandering of the sheet S based on a measurement performed by the meandering detection sensor. At this time, the sheet S is wound on the meandering correction rollers 5a, and thus a meandering correction function can be improved.

The conveyance detection portion 6 is a unit for detecting a tension when tension conveyance is performed between the first main conveyance portion 4 and the second main conveyance portion 14. In addition, the conveyance detection portion 6 is a unit for detecting the speed of the sheet S in order to control an image forming timing of the recording portion 8.

The detection portion 7 includes a mark detection unit 60 for detecting a mark printed on the sheet S in advance, in order to control the image forming timing of the recording portion 8. In addition, there is a risk that, if the sheet S is conveyed in a state of excessively floating from the conveyance path P, and scrapes against a recording head 22 of the recording portion 8, a nozzle surface of the recording head 22 will be broken, and a discharge failure will occur, resulting in damage to the recording heads 22. In view of this, the detection portion 7 is includes a floating detection unit 50 provided as a floating detection portion for detecting a floating amount of the sheet S on the conveyance path P. The floating detection unit 50 opposes a portion of the sheet S that is between two adjacent guide rollers, and detects an amount by which the sheet S separates from a tangent line that connects the two adjacent guide rollers.

The recording portion 8 is a sheet processing portion that performs recording processing on the sheet S conveyed thereto, from above by the recording heads 22, and forms an image. The recording heads 22 are discharging heads for discharging a liquid such as ink toward a recording side of the sheet S. In the recording portion 8, the conveyance path includes a plurality of guide rollers 23 arranged in an arc shape bulging upward, and when a tension is applied to the sheet S, the sheet S is disposed so as to lie along the guide rollers 23 at the same winding angle. Note that the winding angle is a central angle of an arc portion that is an abutment portion between the sheet S and each guide roller. As a result of the sheet S being wound on the guide rollers 23, a clearance between the sheet S and the recording heads 22 is secured.

In this example where the plurality of recording heads 22 are aligned along the conveying direction of the sheet S, the recording portion 8 includes eight line recording heads in total, which respectively correspond to four colors, namely Bk (black), Y (yellow), M (magenta), and C (cyan), a reaction liquid, and three characteristics. Note that the number of colors or the number of recording heads 22 are not limited to eight. As an inkjet method, it is possible to adopt a method that uses a heater element, a method that uses a piezo element, a method that uses an electrostatic element, a method that uses a MEMS element, and the like. These colors of ink are supplied from ink tanks (not illustrated) to the recording heads 22 via corresponding ink tubes.

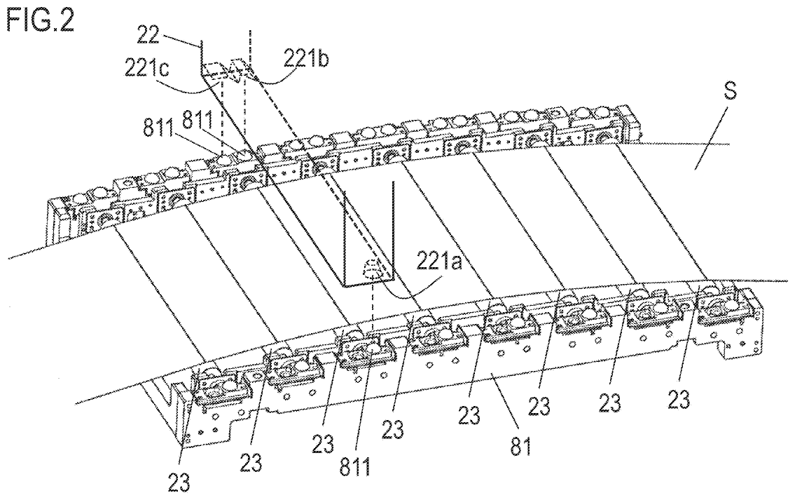

In addition, the recording portion 8 includes a conveyance portion case 81 that includes a plurality of positioning members 811 for positioning the recording heads 22. FIG. 2 is a perspective view showing the conveyance portion case 81 of the recording portion 8 in detail. One positioning member 811 is provided on the front side of each recording head 22 and two positioning members 811 are provided on the rear side, so as to sandwich the sheet S in the width direction of the sheet S. In addition, positioning portions 221a, 221b, and 221c respectively corresponding to the positioning members 811 are provided in each recording head 22.

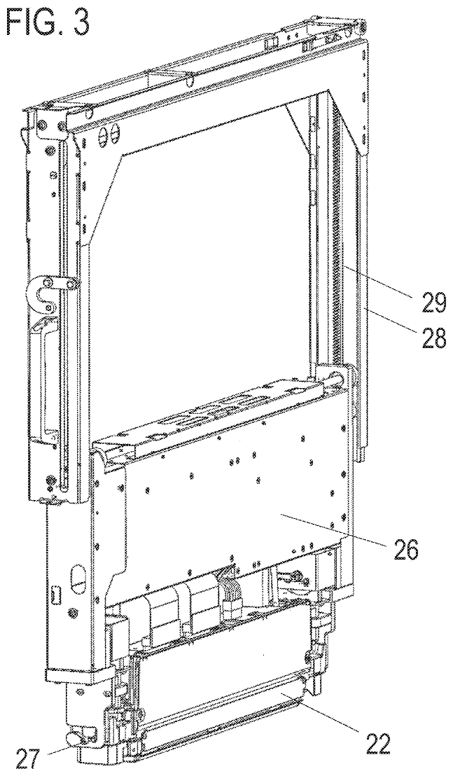

The recording heads 22 oppose the recording side of the sheet S, and are configured to be capable of approaching and separating from the sheet S. FIG. 3 is a diagram showing a lifting and lowering mechanism for a recording head 22. Each recording head 22 includes a supporting shaft 27 that protrudes in the width direction of the sheet S. The supporting shaft 27 of the recording head 22 is pivotally supported by a holding portion 26 and vertically moves in integration with the holding portion 26. The holding portion 26 performs a vertical lifting-lowering operation along lifting-lowering rails 29 provided in a frame 28 for lifting and lowering the recording head, due to a drive mechanism (not illustrated) provided in the holding portion 26.

The first scanner portion 9 is a unit for reading an image formed on the sheet S by the recording portion 8 during printing, detecting misalignment and density of the image, and correcting printing.

The first drying portion 10 and the second drying portion 11 are units for reducing moisture contained in ink provided on the sheet S by the recording portion 8, and increasing the fixity between the sheet S and the ink. The second drying portion 11 is disposed downstream of the first drying portion 10 in the conveying direction of the sheet S. The first drying portion 10 and the second drying portion 11 heat the sheet S subjected to recording, and dry the applied ink. In the first drying portion 10 and the second drying portion 11, hot air is blown onto the sheet S that is moving therethrough, from at least the ink applying side, and the ink applying side (recording side) of the sheet S is dried. Note that, as a drying method, besides the method for blowing hot air, a method for emitting electromagnetic waves (ultraviolet ray, infrared ray, or the like) onto the sheet S and a conductive heat transfer method for bringing the sheet into contact with a heating body may be combined.

A winding guide roller 31 is a roller for winding, at a certain winding angle, the sheet S at a location downstream of the recording portion 8 in the conveyance such that a side of the sheet S opposite to the ink applying side thereof faces the winding guide roller 31, since there is a need to block the influence on the recording portion 8 from hot air from the first drying portion 10. In this example, two winding guide rollers 31 are disposed between the first scanner portion 9 and the first drying portion 10, and the sheet S is folded on the upper side and the lower side of the apparatus so as to be substantially in parallel. The first drying portion 10 is disposed under the recording portion 8 in the apparatus, and the second drying portion 11 is disposed under the aforementioned conveyance detection portion 6 and detection portion 7 in the apparatus.

The cooling portion 12 cools the sheet S fixed by the first drying portion 10 and the second drying portion 11, to solidify the softened ink, and suppresses a temperature change amount of the sheet S in later-stage processes of the recording apparatus 1. In the cooling portion 12, air of a lower temperature than the sheet S is blown onto the sheet S moving therethrough, at least from the ink applying side, and the ink applying side of the sheet S is cooled. Note that the cooling method is not limited to a method for blowing air, and a conductive heat transfer method for bringing the sheet into contact with a heat dissipation member or a combination of the above methods may also be used.

The second scanner portion 13 is a unit for reading a test image formed on the sheet S by the recording portion 8 before printing, detecting misalignment and the density of the image, and performing correction for real printing.

The second main conveyance portion 14 is a unit for conveying the sheet S in cooperation with the first main conveyance portion 4 while applying a tension to the sheet S, and adjusting the tension of the sheet S. The second main conveyance portion 14 is rotated by being driven by a motor (not illustrated), and adjusts the tension of the sheet S based on a tension value detected by the conveyance detection portion 6. In the first embodiment, a clutch 141 capable of controlling driven-connected torque is used to adjust the tension of the sheet S. Note that, as an additional configuration for adjusting the tension of the sheet S, a configuration for controlling the speed of the second main conveyance portion 14 using a tension detection portion 61 may also be added. In this case, the recording apparatus 1 uses, as tension control methods, two methods, namely a torque control method for controlling a torque value transmitted from the clutch and a speed control method for controlling the speed of rollers of the second main conveyance portion 14. These tension control methods can be switched or both of the methods can be used at the same time according to a purpose.

The second dancer portion 15 is a unit for applying a certain sheet tension between the second main conveyance portion 14 and the winding roll portion 16. A tension providing means (not illustrated) of the second dancer portion 15 applies a tension to the sheet S.

The winding roll portion 16 is a unit for winding the sheet S subjected to recording processing, on a winding core. The number of rolls that can collect a sheet is not limited to one, and a configuration may also be adopted in which the winding roll portion 16 includes two winding cores, or three or more winding cores, which are switched so as to alternatively collect the sheet S. Note that, depending on processing content after recording processing, the winding roll portion 16 may be configured such that a continuous sheet is cut into sheets S using a cutter and the sheets S are loaded, in place of a configuration for winding a sheet on a winding core.

A control portion 21 is a unit for controlling the portions of the entire recording apparatus. The control portion 21 includes a CPU, a storage device, a controller that includes various control portions, an external interface, and an operation portion 24 through which user performs input/output operations. Operations of the recording apparatus 1 are controlled based on an instruction from the controller or a host apparatus 25 such as a host computer connected to the controller via the external interface. The control configuration of the recording apparatus 1 will be described later in detail.

The maintenance portion 17 is a unit that has a mechanism for recovering the discharge performance of the recording heads 22. As the mechanism for recovering the discharge performance, a capping mechanism for protecting ink discharge surfaces of the recording heads 22, a wiper mechanism for wiping the ink discharge surfaces, and a sucking mechanism for negative-pressure sucking ink in the recording heads 22 from the ink discharge surfaces, for example, can be adopted. In addition, the maintenance portion 17 has a drive mechanism (not illustrated) and a rail. The recovery mechanism of the maintenance portion 17 is configured to be reciprocally movable in the horizontal direction along the rail, moves to a position directly below a recording head 22 for performing maintenance of the recording head 22, and moves to a position withdrawn from the position directly below the recording head 22 when a maintenance operation is not performed.

### Floating Detection Mechanism

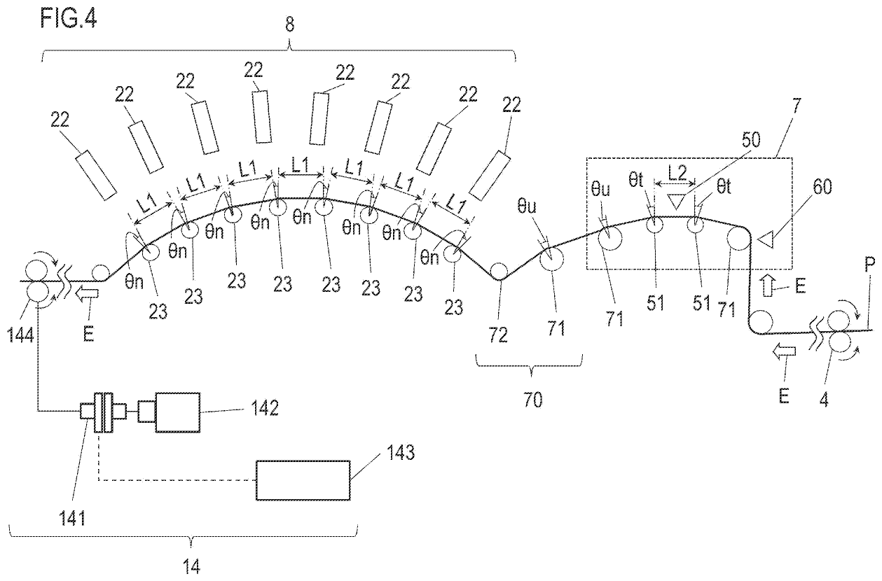

Next, a floating detection mechanism for detecting an amount of floating of the sheet S from the conveyance path P, the sheet S being conveyed along the conveyance path P, according to the first embodiment will be described. FIG. 4 is a schematic diagram of the conveyance path P for the sheet S from the detection portion 7 to the recording portion 8. In FIG. 4, as described above, a tension is applied to the sheet S by the first main conveyance portion 4 and the second main conveyance portion 14, and the sheet S is conveyed in the arrow E direction while being supported by a plurality of guide rollers provided between the first main conveyance portion 4 and the second main conveyance portion 14.

The second main conveyance portion 14 includes rollers 144 for conveying the sheet S, the clutch 141 for controlling the torque of the rollers 144, a drive motor 142 for rotating and driving the rollers 144, and a tension control portion 143. In the second main conveyance portion 14, the rollers 144 are driven and rotated by the drive motor 142, and the tension of the sheet S is adjusted by the clutch 141 for controlling the torque of the rollers 144. In adjustment of the tension of the sheet S, a tension value detected by the tension detection portion 61 of the conveyance detection portion 6 is received by the tension control portion 143, and the second main conveyance portion 14 is operated. The sheet S is supported so as to be wound on and lie along the rollers disposed inside the recording apparatus 1, due to the applied tension. In the first embodiment, an electromagnetic clutch is used as the clutch 141, but the tension of the sheet S may also be adjusted by another mechanism that has similar performance.

The conveyance path P for the sheet S formed inside the recording portion 8 is a path that connects tangent lines of the plurality of guide rollers 23 arranged in an arc shape bulging to the recording head 22 side. Specifically, guide rollers 23 are disposed upstream and downstream of each recording head 22, and are spaced from each other by a distance L1, and the conveyance path P is linearly formed between two guide rollers 23. Note that rollers are disposed at different distances and with different positional relations, downstream of the recording head 22 positioned at the most downstream in the conveying direction of the sheet S. The conveyance path P is also linearly formed between the recording head 22 at the most downstream and a roller provided downstream of the recording head 22 in the conveying direction. In other words, a conveyance path surface is formed so as to support the sheet S between guide rollers 23 adjacent to each other. In the first embodiment, the conveyance path P is formed such that the sheet S is wound on the guide rollers 23 at a winding angle θn. In addition, the plurality of recording heads 22 opposes the conveyance path P in the gravity direction above the guide rollers 23, and are arranged in an arc shape during a recording operation (printing) similarly to the conveyance path P.

The detection portion 7 is provided with two guide rollers 51 and two guide rollers 71. The conveyance path P for the sheet S formed inside the detection portion 7 is a path formed so as to simulate the conveyance path P inside the recording portion 8. The conveyance path P in the detection portion 7 will be described later in detail.

In the first embodiment, as shown in FIGS. 1 and 4, the detection portion 7 is installed upstream of the recording portion 8 in the conveying direction, and floating detection is performed on the sheet S immediately before a recording operation. When an excessive floating amount of the sheet S is detected, a conveyance operation and a recording operation of the sheet S are stopped in order to prevent damage to the recording heads 22. However, when the conveyance speed of the sheet S is high, and the detection portion 7 and the recording portion 8 are disposed extremely close, there is a risk that the conveyance operation cannot be stopped in time and the sheet S will collide with a recording head 22. In view of this, in the first embodiment, a connection portion 70 constituted by a guide roller 71, a guide roller 72, and the like is provided between the detection portion 7 and the recording portion 8. Since the connection portion 70 is provided between the detection portion 7 and the recording portion 8, and there is a certain distance on the conveyance path P between the detection portion 7 and the recording portion 8, a stopping distance of the sheet S is secured. Eventually, when the sheet S excessively floats, even the recording apparatus 1 that supports high-speed operations can stop a conveyance operation before the sheet S reaches the recording heads 22, and prevent damage to a recording head 22. The conveyance path P in the connection portion 70 will be described later in detail.

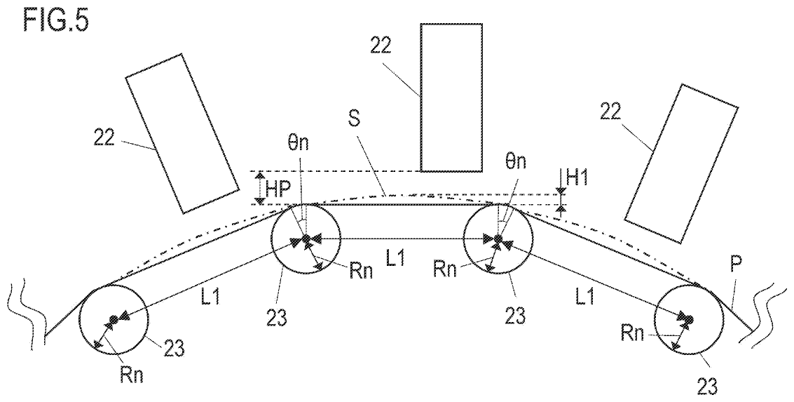

Next, the conveyance path P in the recording portion 8 and the state of the sheet S that is being conveyed in the recording portion 8 will be described in more detail. FIG. 5 is a schematic diagram showing the sheet S being conveyed in the recording portion 8, and the sheet S that is being conveyed is indicated by the dashed-dotted line. In the recording portion 8, the guide rollers 23 having a radius Rn are arranged in an arc shape bulging to the recording head 22 side, and the conveyance path P is shaped as a curved line formed by tangent lines that connect adjacent guide rollers 23 at the winding angle θn. The winding angle θn is the central angle of an arc portion that is an abutment portion between the sheet S and each guide roller 23, and is defined by the positions of the plurality of guide rollers 23 and the radius Rn of the guide rollers 23. The sheet S is then conveyed roughly along the conveyance path P, but is conveyed in a state of floating from the conveyance path P toward the recording head 22 side, between adjacent guide rollers 23.

A gap HP between a recording head 22 and the conveyance path P is often a narrow gap in order to improve the discharge accuracy, and is about 1 mm in general. On the other hand, as described above, in the recording portion 8 in which the guide rollers 23 are arranged in an arc shape, the sheet S is conveyed so as to float toward the recording head 22 side from the conveyance path P, and thus there is a risk that, when the gap HP is excessively small, the sheet S will scrape against a recording head 22. FIG. 5 shows the sheet S being conveyed and bulging toward the recording head 22 side from the conveyance path P by a floating amount H1 at a maximum. That is to say, in the recording portion 8, the sheet S is conveyed and bent such that the recording side of the sheet S bulges due to the guide rollers 23.

When the floating amount H1 exceeds the gap HP, the sheet S may scrape against the nozzle surface of the recording head 22, and the recording heads 22 may be damaged or the like. A case where the floating amount of the sheet S increases and H1 exceeds HP is likely to occur when a tension is insufficient, or when the user uses a sheet or the like for the first time and sets a tension without clearly recognizing a physical property values such as a sheet rigidity.

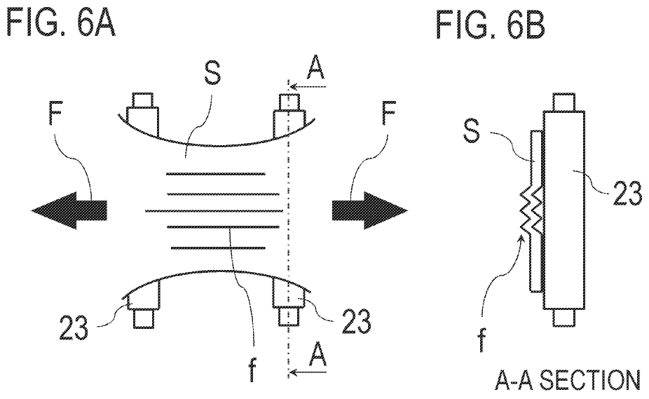

In addition, there are also cases where, when a set tension of the sheet S is too intense, the sheet S creases and a crease portion of the sheet S scrapes against the nozzle surface of a recording head 22. FIGS. 6A and 6B show sheet states under a tension overload, namely when an excessive tension Facts on the sheet S, and crease f is formed in the sheet S. If the crease f floats to the recording head 22 side of the sheet S while the sheet S is conveyed, there is a risk that the floating amount H1 will exceed the gap HP, and the crease f of the sheet S will scrape against the nozzle surface of the recording head 22. Therefore, regardless of whether the set tension of the sheet S is too large or too small, there is a risk that the sheet S will scrape against a recording head 22, and the recording heads 22 will be damaged. Furthermore, even if the set tension is appropriate, H1 may exceed HP and the recording heads 22 may be damaged when a curl in the width direction of the sheet S changes significantly while the sheet S is conveyed, or when an extraneous material unintendedly adheres to the sheet S, or the like. Therefore, in order to suppress damage to the recording heads 22, there is a need to be aware of a change in the sheet state during a recording operation in addition to a sheet state before the recording operation.

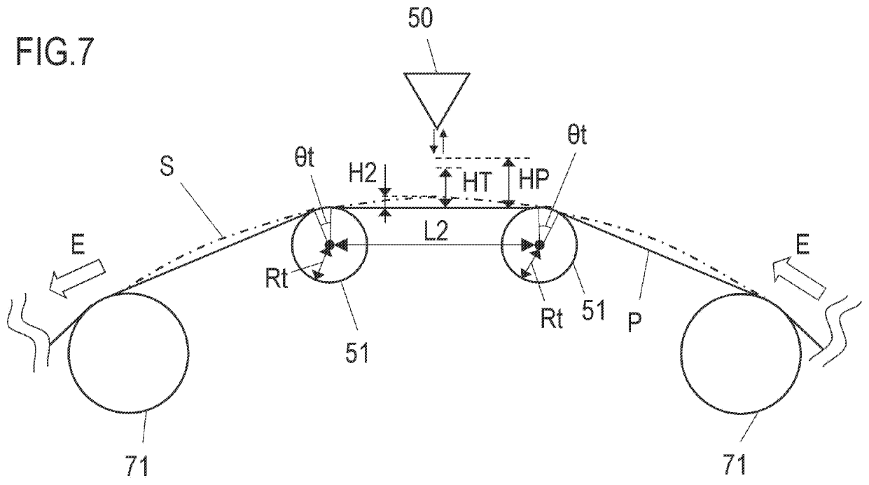

Next, the conveyance path P in the detection portion 7 and the state of the sheet S that is being conveyed in the detection portion 7 will be described in more detail. FIG. 7 is a schematic diagram showing the sheet S being conveyed in the detection portion 7, and the sheet S that is being conveyed is indicated by a dashed-dotted line. In the detection portion 7, the two guide rollers 51 and the two guide rollers 71 are disposed below the floating detection unit 50 in the gravity direction. The two guide rollers 51 are aligned spaced apart from each other in the conveying direction by a distance L2, the guide rollers 71 are disposed respectively upstream and downstream of the guide rollers 51 in the conveying direction. The conveyance path P is linearly formed between guide rollers aligned next to each other, thus forming a conveyance path surface. In the first embodiment, the conveyance path P is formed such that an arc portion thereof lies along each of the guide rollers 51 having a radius Rt, at the winding angle θt. The winding angle θt is the central angle of the arc portion that is an abutment portion between the sheet S and the guide roller 51.

The guide rollers 51 and 71 are arranged such that the conveyance path P in the detection portion 7 is formed in a similar manner to the conveyance path P in the recording portion 8. That is to say, the conveyance path P in the detection portion 7 is formed in a similar manner to the conveyance path P in the recording portion 8. Furthermore, the floating detection unit 50 of the detection portion 7 is disposed such that the positional relation between the conveyance path P and the floating detection unit 50 is similar to the positional relation between the conveyance path P and the recording heads 22 of the recording portion 8. Therefore, in the detection portion 7, the sheet S is conveyed and bent such that the recording side of the sheet S bulges due to the guide rollers 51.

Specifically, the distance L2 based on which the two guide rollers 51 of the detection portion 7 are disposed is equivalent to the distance L1 based on which the two guide rollers 23 of the recording portion 8 are disposed. In addition, the radius Rt of the guide rollers 51 is equivalent to the radius Rn of the guide rollers 23, and the winding angle θt for the guide rollers 51 is equivalent to the winding angle θn for the guide rollers 23. In short, the detection portion 7 is configured such that L2=L1, Rt=Rn, and θt=θn. Due to such a configuration, the sheet state in the recording portion 8 is regenerated in the detection portion 7, and a floating amount H2 of the sheet S in the detection portion 7 is substantially equivalent to the floating amount H1 of the sheet S in the recording portion 8. Therefore, the floating amount of the sheet S in the recording portion 8 can be detected by the detection portion 7 in advance, and thus it is also possible to grasp a change in curl in the sheet width direction, unintended attachment of an extraneous material, and the like immediately before a recording operation.

As described above, the floating detection unit 50 opposes the conveyance path P formed between the two guide rollers 51. That is to say, in the detection portion 7, the floating amount H2 of the sheet S between the two guide rollers 51 is detected by the floating detection unit 50. Moreover, in the first embodiment, when the floating amount H2 exceeds a floating amount threshold value HT that is an allowable upper limit value, a conveyance operation and the like of the sheet S are stopped. In the first embodiment, the floating amount threshold value HT is set to a value smaller than the gap HP between the conveyance path P and the recording heads 22 of the recording portion 8. By performing settings in this manner, it is possible to more reliably suppress damage to the recording heads 22.

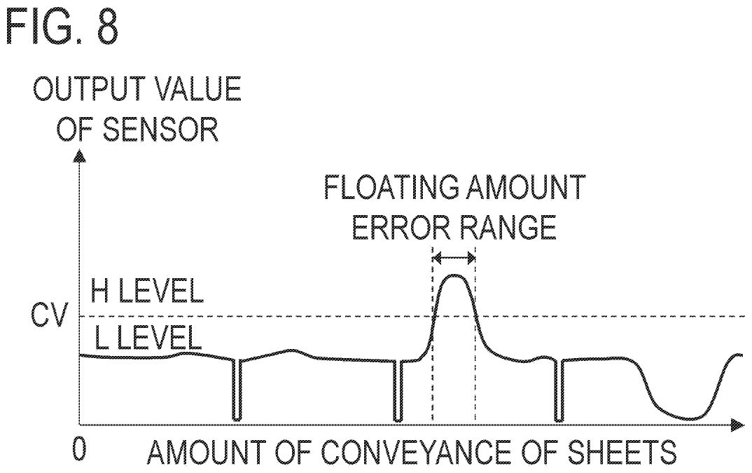

Next, the sensor of the floating detection unit 50 will be described in more detail. FIG. 8 is a diagram illustrating an example of a sensor output waveform of the floating detection unit 50. In the graph shown in FIG. 8, the vertical axis indicates output value of the sensor, and the horizontal axis indicates conveyance amount of the sheet S, showing changes in the output value detected by the sensor. The sensor of the floating detection unit 50 according to the first embodiment is a reflective sensor, and the larger the distance between the sensor and the sheet S is, the larger the output value of the sensor becomes. That is to say, the floating detection unit 50 detects the floating amount H2 of the sheet S from the conveyance path P by measuring the distance between the sensor and the sheet S. When the sensor and the sheet S are separated (paper floating is small), an output level is small, and is L level, but, when the distance between the sensor and the sheet S decreases (paper floating is large), an output level increases to H level.

If an output value detected by the floating detection unit 50 exceeds an output threshold value CV, detection information is transmitted to the control portion 21, and processing for stopping the conveyance operation and the recording operation after detection is performed. In the first embodiment, the output threshold value CV is a value when the floating amount H2 of the sheet S in the detection portion 7 is the floating amount threshold value HT. That is to say, when the floating amount H2 of the sheet S exceeds the floating amount threshold value HT, and the output value of the sensor exceeds the output threshold value CV, it is determined that the floating amount of the sheet S is excessive, and the conveyance operation and the recording operation of the sheet S are stopped. FIG. 8 shows a range of the output value of the sensor that exceeds the output threshold value CV, as a floating amount error range.

Note that the floating detection unit 50 according to the first embodiment uses a reflective photoelectronic sensor as a displacement sensor, but a sensor that can measure displacement in a similar manner, such as an electrostatic sensor, a contact type sensor, or the like may also be used. In addition, as shown in FIG. 7, in the first embodiment, displacement measurement is performed from above the sheet S, but a line sensor that performs scanning in the sheet width direction or the like may also be disposed so as to execute floating detection of the sheet S. That is to say, a detection means and a detection direction of the detection portion 7 are not limited to the above configuration, and another known detection unit may be adopted as long as it has a configuration in which displacement can be measured in a similar manner.

Accordingly, due to the above configuration, by the floating detection unit 50 measuring the floating amount H2 of the sheet S, it is possible to estimate the floating amount H1 of the sheet S positioned below the recording heads 22, and to confirm in advance whether or not the floating amount of the sheet S is within an acceptable range.

### Configuration for Suppressing Peeling of Base Material Layer of Label Roll

Incidentally, the recording apparatus 1 according to the first embodiment can record an image onto not only roll paper having a single-layer configuration, as a type of sheet S, but also a label roll having a layered configuration consisting of a base material layer, an adhesive layer, and a release layer, for example, in a similar manner. Also when a recording operation is performed on a label roll, an image is formed, by the recording heads 22 of the recording portion 8, onto the base material layer of the label roll unwound from the unwinding roll portion 2, while the label roll is tension-conveyed between the first main conveyance portion 4 and the second main conveyance portion 14. A portion of the label roll where the image is formed moves through the first drying portion 10, the second drying portion 11, and the cooling portion 12, and is then wound on a winding core of the winding roll portion 16.

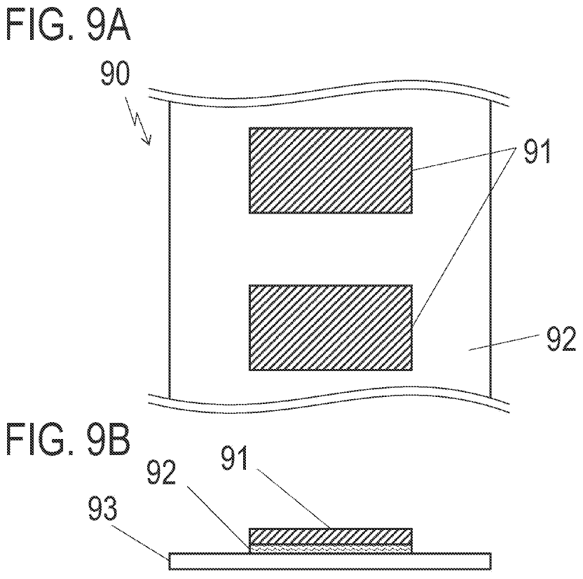

Examples of the label roll include a roll that includes a base material layer subjected to half-cutting processing and a release layer whose portion is cut, a roll subjected to waste removing processing for cutting away a portion of a base material layer, and the like. FIG. 9A is a top view of a label roll 90 subjected to waste removing processing, and FIG. 9B is a front view of the label roll 90 subjected to waste removing processing. The label roll 90 includes a base material layer 91 that has a recording side, a release layer 93, and an adhesive layer 92 for adhering the base material layer 91, the release layer 93, and the like to each other. When the label roll 90, which is an example of a roll subjected to waste removing processing, is conveyed in the recording apparatus 1, there are cases where, in a portion of the label roll 90 where the winding angle at which the label roll 90 is wound on a guide roller is large, the adhesive layer 92 or the base material layer 91 peels away from the release layer 93.

Next, a peeling test of the base material layer 91 and the adhesive layer 92 (hereinafter, a “label”) of the label roll 90 will be described. In a label peeling test, various parameters that can affect the likelihood of label peeling were changed, and examination was conducted as to whether or not a label peels away when the label roll 90 is wound on a guide roller 85 and moves past the guide roller 85. The guide roller 85 is a roller for the label peeling test. In this test, the thickness of the base material layer 91, adhesion force of the adhesive layer 92, a winding angle θp for the guide roller 85, and a diameter op of the guide roller 85 were changed. In addition, the base material layer 91 in this test was high-quality paper.

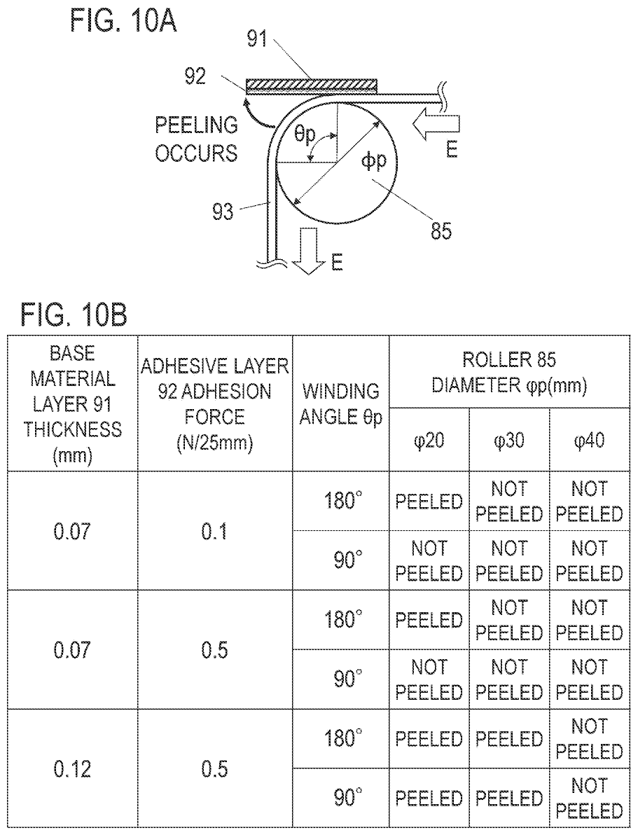

FIG. 10A shows a state where, when the label roll 90 subjected to waste removing processing is conveyed while being wound on the guide roller 85, the base material layer 91 and the adhesive layer 92 (hereinafter, a “label”) peel away from the release layer 93. FIG. 10B is a table showing results of the label peeling test. In the label peeling test, the thickness of the base material layer 91 was changed between two conditions, namely 0.07 and 0.12 [mm], and the adhesion force of the adhesive layer 92 was changed between two conditions, namely 0.1 and 0.5 [N/25 mm]. In addition, in the label peeling test, the winding angle θp was changed between two conditions, namely 90 and 180 [deg], and the diameter op of the guide roller 85 was changed between three conditions, namely 20, 30, and 40 [mm]. In the table in FIG. 10B, a condition under which at least a portion of the label peeled is indicated by “peeled”, and a condition under which the label did not peeled is indicated by “not peeled”.

When the thickness of the base material layer 91 was 0.07 [mm], the adhesion force of the adhesive layer 92 was 0.1 [N/25 mm], and the winding angle θp was 180 [deg], the label peeled if the diameter φp was 20 [mm], but the label did not peel if the diameter φp was 30 or 40 [mm]. When the thickness of the base material layer 91 was 0.07 [mm], the adhesion force of the adhesive layer 92 was 0.1 [N/25 mm], and the winding angle θp was 90 [deg], the label did not peel under any of the conditions that the diameter φp is 20, 30, and 40 [mm].

When the thickness of the base material layer 91 was 0.07 [mm], the adhesion force of the adhesive layer 92 was 0.5 [N/25 mm], and the winding angle θp was 180 [deg], the label peeled if the diameter φp was 20 [mm], but the label did not peel if the diameter φp was 30 or 40 [mm]. When the thickness of the base material layer 91 was 0.07 [mm], the adhesion force of the adhesive layer 92 was 0.5 [N/25 mm], and the winding angle θp was 90 [deg], the label did not peel under any of the conditions that the diameter φp is 20, 30, and 40 [mm].

When the thickness of the base material layer 91 was 0.12 [mm], the adhesion force of the adhesive layer 92 was 0.5 [N/25 mm], and the winding angle θp was 180 [deg], the label peeled if the diameter φp was 20 and 30 [mm], but the label did not peel if the diameter φp was 40 [mm]. When the thickness of the base material layer 91 was 0.12 [mm], the adhesion force of the adhesive layer 92 was 0.5 [N/25 mm], and the winding angle θp was 90 [deg], the label peeled if the diameter φp was 20 and 30 [mm], but the label did not peel if the diameter φp was 40 [mm].

According to the above test results, the larger the thickness of the base material layer 91 is, the more the label is likely to peel. Similarly, the larger the winding angle θp is, the more the label is likely to peel, and the smaller the diameter φp of the guide roller 85 is, the more the label is likely to peel. Factors for peeling includes the influence from the circumference difference of a winding portions, and, in addition, peeling occurs when the restoring force of the base material layer 91 against deflection is larger than the adhesion force of the adhesive layer 92. That is to say, with a focus on a winding portion that is the abutment portion between the guide roller 85 and the sheet S, it is conceivable that an index indicating the likelihood of the label peeling away from the label roll 90 can be represented by a camber (the arc height of the arc portion) of the base material layer 91.

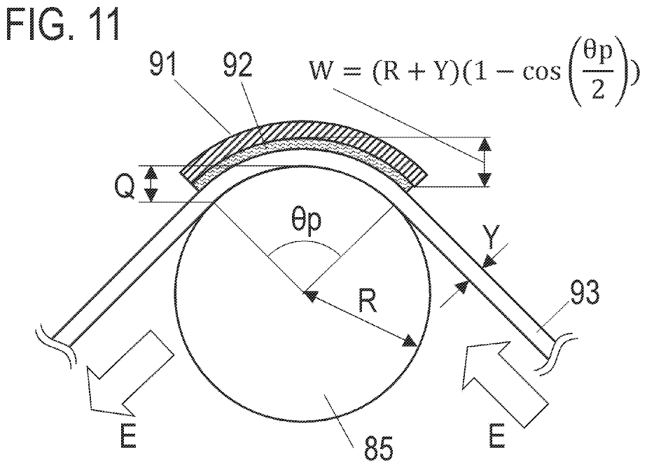

FIG. 11 is a diagram illustrating the winding portion of the guide roller 85 of the label roll 90. A camber W of the base material layer 91 is a so-called deflection amount of the base material layer 91. Here, as viewed along the rotation axis line direction of the guide roller 85, the camber W of the base material layer 91 is the arc height from the chord to the apex of the arc portion of the base material layer 91 when the label roll 90 is wound on the guide roller 85. That is to say, the camber W of the base material layer 91 depends on the thickness of the release layer 93 and an arc height Q of the arc portion, which is the abutment portion between the label roll 90 and the guide roller as viewed along the rotation axis line of the guide roller 85. Letting the thickness of the release layer 93 be Y, and the radius of the guide roller 85 be R (=φp/2), the camber W on the inner peripheral surface side of the base material layer 91, which is a peeling index, is obtained based on Expression 1 below. Note that the thickness of the adhesive layer 92 is infinitesimally small, and is sufficiently small compared with the thickness Y of the release layer 93.

$$W = ( R + Y ) ( 1 - cos ( \frac{θ p}{2} ) ) \qquad Expression ( 1 )$$

If the label of the label roll 90 enters the recording portion 8 in a state where the label is peeled, there is a risk that the label will scrape against a recording head 22, causing damage to the recording head 22. In view of this, the recording apparatus 1 according to the first embodiment is configured such that the detection portion 7 can also detect label peeling of a label roll subjected to waste removing processing, in addition to floating detection of the sheet S. As described above, the floating detection unit 50 is disposed upstream of the recording portion 8 in the conveying direction, and includes a displacement sensor. Therefore, if a label peels away from the release layer 93 and approaches a recording head 22, the floating detection unit 50 detects the label peeling. By detecting label peeling and stopping conveyance of the label roll 90 before the label-peeled portion of the label roll 90 enters the recording portion 8, it is possible to keep the label-peeled portion from scraping against the nozzle of the recording head 22.

However, in a case where the label roll 90 moves through the floating detection unit 50 and a label then peels before the label roll 90 enters the recording portion 8, the floating detection unit 50 cannot detect the label peeling, and there is a risk that the label will scrape against a recording head 22. In view of this, in the first embodiment, in order to suppress label peeling and increase a damage suppressing effect of the recording heads 22, the guide rollers 71 and 72 are disposed between the floating detection unit 50 and the recording portion 8, forming the conveyance path P.

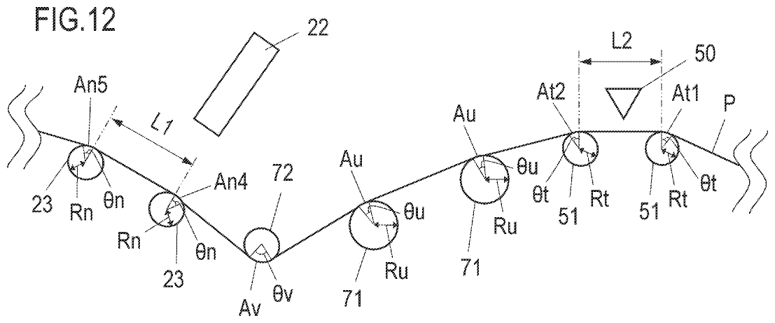

Next, the conveyance path P extending from the detection portion 7 to the recording portion 8 via the connection portion 70 will be described in detail. FIG. 12 shows the conveyance path P from the detection portion 7 to the recording portion 8. The two guide rollers 71 and one guide roller 72 are disposed between the guide rollers 51 of the detection portion 7 and the guide rollers 23 of the recording portion 8. The guide rollers 71 are disposed so as to bend the sheet S such that the recording side of the sheet S forms a protrusion. On the other hand, the guide roller 72 is disposed downstream of the guide rollers 71 in the conveying direction, and the sheet S is conveyed along the outer peripheral surface of the guide roller 72 such that the back side, namely a side of the sheet S opposite to the recording side thereof bulges. That is to say, in order to form the conveyance path P, a plurality of guide rollers are disposed between the detection portion 7 and the recording portion 8 in the order of the guide rollers 51, the guide rollers 71, the guide roller 72, and the guide rollers 23.

Letting a first rotating member be the guide roller 51 positioned upstream of the floating detection unit 50 in the conveying direction, and letting a second rotating member be the guide roller 51 positioned downstream of the floating detection unit 50 in the conveying direction, the radius of the first rotating member and the radius of the radius of the second rotating member are equivalent, that is, the radius Rt. Also, letting a first arc portion At1 be the abutment portion between the sheet S and the first rotating member, and letting a second arc portion At2 be the abutment portion between the sheet S and the second rotating member, the central angle of the first arc portion At1 and the central angle of the second arc portion At2 are equivalent, that is, the winding angle θt.

As described above, the camber of the sheet S such as the label roll 90 depends on the arc height of the arc portion, namely the abutment portion between the sheet S and each guide roller. In addition, the arc height depends on the radius of the guide roller and the winding angle of the sheet S relative to the guide roller. That is to say, letting a first arc height Qt1 be the arc height of the first arc portion At1, and letting a second arc height Qt2 be the arc height of the second arc portion At2, the first arc height Qt1 and the second arc height Qt2 are equivalent. Also, the camber of the sheet S when it lies along the first arc portion At1 and the camber of the sheet S when it lies along the second arc portion At2 are equivalent, that is, the camber Wt. Therefore, the likelihood of label peeling does not virtually differ when the label roll 90 is conveyed along the first rotating member and when the label roll 90 is conveyed along the second rotating member. Eventually, after floating detection is performed by the floating detection unit 50, the likelihood of label peeling is low when the label roll 90 is conveyed along the guide roller 51 that is the second rotating member. In other words, in order to suppress label peeling, it is sufficient that the central angle of the second arc portion At2 is smaller than or equal to the central angle of the first arc portion At1, and the second arc height Qt2 of the second arc portion At2 is smaller than or equal to the first arc height Qt1 of the first arc portion At1.

Next, assuming that the guide roller 71 positioned downstream of the guide rollers 51 in the conveying direction is a third rotating member, the abutment portion between the sheet S and the third rotating member is a third arc portion Au, and the arc height of the third arc portion Au is a third arc height Qu, the relation between the first rotating member and the third rotating member will be described in more detail. The radius Ru of the guide roller 71 that is the third rotating member is smaller than the radius Rt of the guide rollers 51 that is the first rotating member. In addition, the guide rollers are disposed such that the winding angle θu, which is the central angle of the third arc portion Au, is smaller than the winding angle θt, which is the central angle of the first arc portion At1. Therefore, the third arc height Qu of the third arc portion Au is smaller than the first arc height Qt1 of the first arc portion At1, and the camber Wu of a portion of the sheet S that lies along the third arc portion Au is smaller than the camber Wt of a portion of the sheet S that lies along the first arc portion At1.

To summarize the relation between the guide rollers 71 and the guide rollers 51, the relation between the radiuses is Ru>Rt, the relation between the winding angles is θu<θt, the relation between the arc heights of the arc portions is Qu<Qt1, and the relation between the cambers is Wu<Wt. In other words, the conveyance path P is formed so as to satisfy Wu=(Ru+Y){1−cos (θu/2)}<Wt=(Rt+Y){1−cos (θt/2)} based on Expression 1 above. With such a configuration, a label is less likely to peel away from the label roll 90 where the label roll 90 lies along the guide rollers 71, compared with where the label roll 90 lies along the guide rollers 51. That is to say, when the label roll 90 is conveyed along the conveyance path P, labels are kept from peeling away from the release layer 93 after the label roll 90 moves through the floating detection unit 50 until the label roll 90 reaches the recording portion 8, and damage to the recording heads 22 is suppressed.

Note that, in order to reduce the camber W (deflection amount) of the base material layer 91, the winding angles for the guide rollers are preferably smaller. However, when both the radius and the winding angle of a guide roller are small, there is a risk that a problem of slipping or the like will occur between the label roll 90 and the guide roller if the winding angle is further reduced. In view of this, in the first embodiment, the radiuses and winding angles of the guide rollers and a camber of a recording medium such as the label roll 90 are set while preventing the winding angles from becoming excessively small, and the guide rollers are then disposed.

Accordingly, in the first embodiment, under a condition under which the radiuses of the guide rollers satisfy Ru>Rt and the winding angles for the guide rollers satisfy θu<θt, a camber, which is an index indicating the likelihood of label peeling, is set, and the guide rollers are arranged, forming the conveyance path P. Due to such a configuration, when the label roll 90 is conveyed along the conveyance path P, the likelihood of label peeling is reduced significantly after the floating detection unit 50 performs detection until the label roll 90 reaches the recording heads 22 of the recording portion 8. That is to say, with the recording apparatus 1 according to the first embodiment, label peeling of the label roll 90 can be detected, and label peeling can be suppressed after the label roll 90 moves through the detection portion 7 until the label roll 90 reaches the recording portion 8, and thus damage to the recording heads 22 can be suppressed.

In addition, with a focus on one recording head 22, letting a fourth rotating member be the guide roller 23 positioned upstream of the recording head 22 in the conveying direction, and letting a fifth rotating member be the guide roller 23 positioned downstream of the recording head 22 in the conveying direction, the radius of the fourth rotating member and the radius of the fifth rotating member are equivalent, that is, the radius Rn. In addition, letting a fourth arc portion An4 be the abutment portion between the sheet S and the fourth rotating member, and letting a fifth arc portion An5 be the abutment portion between the sheet S and the fifth rotating member, the central angle of the first arc portion At1 and the central angle of the second arc portion At2 are equivalent, that is, the winding angle θn. Furthermore, the radius Rt of the guide rollers 51 is equivalent to the radius Rn of the guide rollers 23, and the winding angle θt of the guide rollers 51 is equivalent to the winding angle θn of the guide rollers 23.

That is to say, letting a fourth arc height Qn4 be the arc height of the fourth arc portion An4, and letting a fifth arc height Qn5 be the arc height of the fifth arc portion An5, the fourth the arc height Qn4 and the fifth the arc height Qn5 are equivalent. Also, the camber of the sheet S when it lies along the fourth arc portion An4 and the camber of the sheet S when it lies along the fifth arc portion An5 are equivalent, that is, the camber Wn. Therefore, the first arc portion At1, the second arc portion At2, the fourth arc portion An4, the fifth arc portion An5 are all configured similarly, and the first arc height Qt1, the second arc height Qt2, the fourth the arc height Qn4, and the fifth the arc height Qn5 are all equivalent. That is to say, a portion of the conveyance path P that opposes the floating detection unit 50 and a portion of the conveyance path P that opposes the recording heads 22 are configured similarly. Therefore, the likelihood of label peeling does not virtually differ when the label roll 90 is conveyed along a guide roller 51 and when the label roll 90 is conveyed along a guide roller 23. Eventually, after the floating detection unit 50 performs floating detection, the likelihood of label peeling away from the label roll 90 in the recording portion 8 is low.

In addition, in the detection portion 7 and the recording portion 8, the label roll 90 is conveyed along the guide rollers 51 and the guide rollers 23 in a state of being bent such that the recording side (the surface on the base material layer 91 side) thereof bulges. On the other hand, in the connection portion 70, the label roll 90 is conveyed along the outer peripheral surface of the guide rollers 71 in a state of being bent such that the recording side forms a protrusion, and is conveyed along the guide roller 72 in a state of being bent such that the back side, namely the opposite side to the recording side (the surface on the release layer 93 side) bulges. Due to such a configuration, the detection portion 7 and the recording portion 8 can be disposed substantially horizontally, and thus it is possible to reduce the height of the recording apparatus 1 and the product size.

In addition, the guide roller 72 is defined as a sixth rotating member, and the abutment portion between the sheet S and the sixth rotating member is defined as a sixth arc portion Av. At this time, a winding angle θv of the guide roller 72, which is the central angle of the sixth arc portion Av, is larger than the winding angle θt of the guide rollers 51, the winding angle θu of the guide rollers 71, and the winding angle θn of the guide rollers 23. That is to say, the conveyance path P between the detection portion 7 and the recording portion 8 is formed such that the winding angles of the guide rollers satisfy the relation of θv>θt=θn>θu. By setting the winding angle θv of the guide roller 72 positioned at a lower position than the guide rollers 23 and the guide rollers 71 to the largest value, it is possible to reduce the height of the recording apparatus 1 as a product. Note that the guide roller 72 is disposed so as to bend the label roll 90 such that the back side of the label roll 90 bulges, and thus, even if the winding angle θv is set to a large value, the likelihood of label peeling due to the guide roller 72 is low. That is to say, the winding angle θv of the guide roller 72 does not need to be taken into consideration as an index of peeling, and the value thereof is not limited in terms of suppressing label peeling.

Note that, in the first embodiment, the relation between the radius of the guide rollers 51 and the radius of the guide rollers 71, the guide rollers 51 and the guide rollers 71 forming the conveyance path P, is Ru>Rt, but there is necessarily no limitation thereto if a camber of the sheet S satisfies Wu<Wt. If Wu<Wt is satisfied, for example, the conveyance path P may be formed such that the relation between the radiuses is Ru=Rt. That is to say, if the radius of the guide roller 71 that is the third rotating member is larger than or equal to the radius of the guide roller 51 that is the first rotating member, a label peeling suppressing effect can be achieved. In particular, when the radiuses of the guide rollers are close, the likelihood of label peeling mainly depends on the winding angles of the guide rollers, and thus it is important to satisfy θt>θu in order to suppress label peeling.

In addition, as described above, the configuration of the guide rollers of the detection portion 7 and the configuration of the guide rollers of the recording portion 8 are similar, and a plurality of guide rollers are arranged such that a portion of the conveyance path that is in the detection portion 7 and a portion of the conveyance path that is in the recording portion 8 are similar. That is to say, the camber Wn that is calculated from the radius Rn of the guide rollers 23 and the winding angle θn takes the same value as the camber Wt for the guide rollers 51. That is to say, the likelihood of label peeling is similar in the detection portion 7 and the recording portion 8, and, in the first embodiment, the conveyance path P is formed so as to satisfy Wu<Wt=Wn. However, in order to improve the damage suppressing effect of the recording heads 22, the conveyance path P may be configured so as to satisfy Wu<Wn<Wt. That is to say, in order to achieve the damage suppressing effect of the recording heads 22, it suffices for the conveyance path P to be configured such that the camber Wt of a recording medium on each guide roller 51 of the detection portion 7 is smaller than or equal to the camber Wn of the recording medium on each guide roller 23 of the recording portion 8.

### Control Configuration

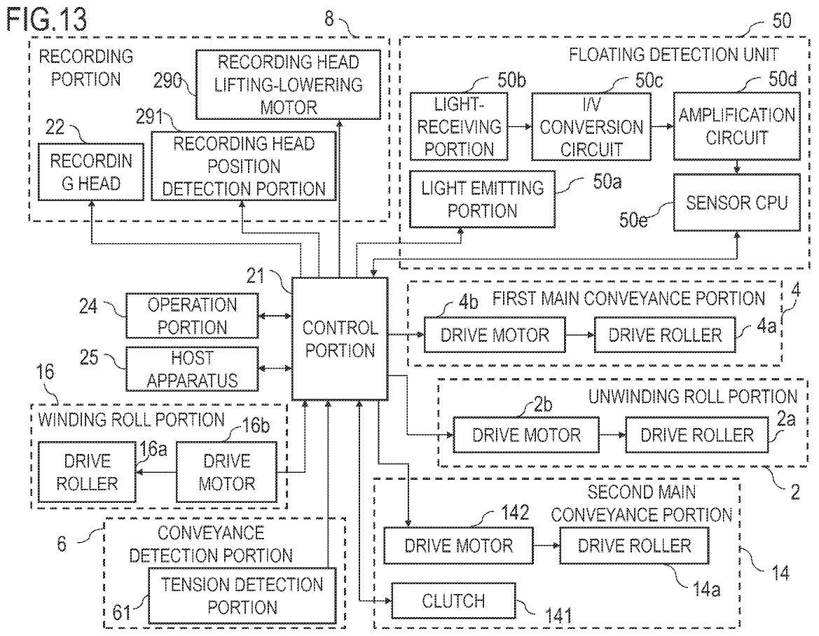

Next, a control configuration of the recording apparatus 1 will be described. FIG. 13 is a block diagram of a control system of the recording apparatus 1 according to the first embodiment. The control portion 21 of the recording apparatus 1 controls operations of the unwinding roll portion 2, the first main conveyance portion 4, the conveyance detection portion 6, the floating detection unit 50, the recording portion 8, the second main conveyance portion 14, the winding roll portion 16, the operation portion 24, and the host apparatus 25.

The first main conveyance portion 4 includes a drive roller 4a and a drive motor 4b for driving the drive roller 4a. In addition, the second main conveyance portion 14 includes a drive roller 14a, the drive motor 142 for driving the drive roller 14a, and the clutch 141. The control portion 21 controls operations of the drive motor 4b and the drive motor 142 to control rotation operations of the drive roller 4a and the drive roller 14a. Furthermore, the control portion 21 controls operations of the second main conveyance portion 14 based on a tension value detected by the tension detection portion 61 of the conveyance detection portion 6, and adjusts the tension value of the sheet S.

The unwinding roll portion 2 includes a drive roller 2a and a drive motor 2b for driving the drive roller 2a. In addition, the winding roll portion 16 includes a drive roller 16a and a drive motor 16b for driving the drive roller 16a. The control portion 21 controls operations of the drive motor 2b and the drive motor 4b, and controls rotation operations of the drive roller 2a and the drive roller 16a.

The floating detection unit 50 includes a light emitting portion 50a, a light-receiving portion 50b, an I/V conversion circuit 50c, an amplification circuit 50d, and a sensor CPU 50e. The control portion 21 controls the light emitting portion 50a to emit light toward a recording medium that is being conveyed along the conveyance path P. In addition, the floating detection unit 50 supplies power from the control portion 21 to the sensor CPU 50e, receives pulse input, and starts a measurement. Note that a set value of the output threshold value CV is held in a memory in the control portion 21, and is updated as necessary after the sheet S is replaced, for example.

After the floating detection unit 50 has started measurement, the control portion 21 continuously receives output from the sensor CPU 50e, and controls the recording portion 8 to stop conveyance of the recording medium when output that exceeds the output threshold value CV is received. The recording portion 8 includes the recording heads 22, a lifting-lowering motor 290 for lifting and lowering the recording heads 22, and a position detection portion 291 for detecting the positions of the recording heads 22. Specifically, the control portion 21 stops a discharge operation of the recording heads 22 of the recording portion 8, and instructs the lifting-lowering motor 290 to move the recording heads 22 to a retreat position distant from the recording medium. After that, when the control portion 21 is notified by the position detection portion 291 that the recording heads 22 have moved to a predetermined retreat position, the control portion 21 issues a stop signal to the lifting-lowering motor 290. The control portion 21 then issues a stop instruction signal to the first main conveyance portion 4, the second main conveyance portion 14, and the drive motors of the unwinding roll portion 2 and the winding roll portion 16, and stops rotation of the drive rollers.

### Floating Detection Method

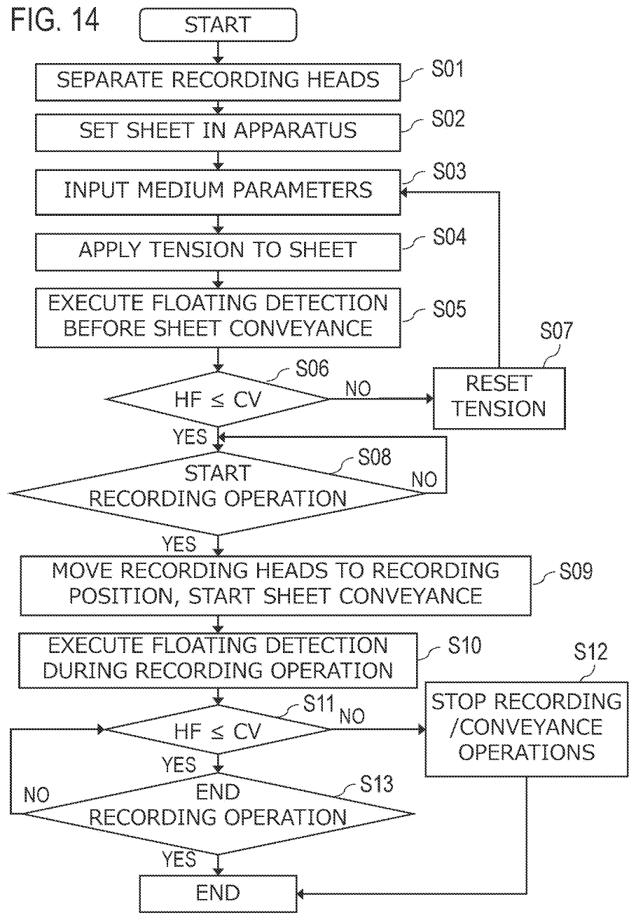

Next, a method for detecting floating of the sheet S, which is performed by the detection portion 7, will be described in detail. FIG. 14 shows a flowchart from a setting process of the sheet S to a recording process, in the recording apparatus 1 according to the first embodiment. The floating detection method according to the first embodiment will be described with reference to the flowchart in FIG. 14.

First, in order to set the sheet S, the recording heads 22 are brought into a separate state (step S01). At this time, as necessary, capping processing and recovery processing may be performed by the maintenance portion 17. Next, the operator sets the sheet S in the recording apparatus 1 (step S02). The operator then inputs medium parameters such as information regarding the sheet S, through the operation portion 24 (step S03).

Next, a tension is applied to the set sheet S (step S04). The value of the tension that is set for the sheet S may be manually input by the operator that understands the sheet properties, or may be selected from recommended parameters set in the apparatus in advance based on similar material properties. After that, the floating detection unit 50 of the detection portion 7 executes floating detection of the sheet S to which the tension has been applied (step S05). At this time, the sheet S is not being conveyed.

If the floating amount H2 of the sheet S being larger than the output threshold value CV is detected in floating detection (NO in step S06), the tension is reset in order to resolve excessive floating of the sheet S (step S07). After the tension is reset, steps S03 to S06 are repeatedly performed again, where medium parameters are input, and a tension of a new tension value is applied to the sheet S.

If the floating amount H2 of the sheet S being smaller than or equal to the output threshold value CV is detected in floating detection (YES in step S06), it is determined that the recording apparatus 1 is in a state where an appropriate tension is set for the sheet S, and the sheet S can be prevented from scraping against the recording heads 22. That is to say, if the floating amount H2 detected by the floating detection unit 50 satisfies H2≤ CV, it is determined that the recording apparatus 1 can execute a recording operation onto the sheet S without any problem.

If a recording operation on the sheet S is started (YES in step S08), the recording heads 22 move to a recording position, and conveyance of the sheet S is started (step S09). After conveyance of the sheet S is started, floating detection of the sheet S that is being conveyed is executed (step S10).

If the floating amount H2 of the sheet S being larger than the output threshold value CV is detected in floating detection (NO in step S11), the recording operation and the conveyance operation of the sheet S are stopped (step S12), and floating detection is stopped. On the other hand, if the floating amount H2 of the sheet S being smaller than or equal to the output threshold value CV is detected in floating detection (YES in step S11), the recording operation continues to be executed. While the recording operation is not complete (NO in step S13), floating detection continues to be performed, and the state of the sheet S is monitored. When the recording operation is complete (YES in step S13), floating detection is also stopped.

By the control portion 21 of the recording apparatus 1 controlling the portions as described above, it is possible to detect a change in curl in the width direction of the sheet S, unintended attachment of an extraneous material to the sheet S, peeling of the base material layer 91 of a label roll subjected to waste removing processing, and the like. Moreover, even during a recording operation and conveyance of the sheet S, the floating detection unit 50 detects the floating amount H2 of the sheet S, and, if the floating amount H2 exceeds the output threshold value CV, the conveyance operation of the sheet S is promptly stopped. Eventually, the sheet S is kept from scraping against a recording head 22, and damage to the recording head 22 is suppressed.

In addition, in the first embodiment, the guide rollers are disposed and the conveyance path P is formed such that peeling of the base material layer 91 can be suppressed in a case where the label roll 90 is used. Therefore, peeling of a label is suppressed after the label roll 90 moves through the detection portion 7 until the label roll 90 reaches the recording portion 8, and damage to the recording heads 22 caused by peeling of the base material layer 91 is suppressed. Accordingly, in the recording apparatus 1 according to the first embodiment, the conveyance path P is formed in consideration of label peeling, and thus, label peeling of even a label roll whose label is likely to peel is suppressed downstream of the detection portion 7 in the conveying direction, and damage to the recording heads 22 can be suppressed.

### Second Embodiment

Next, a second embodiment according to the present invention will be described. The second embodiment is different from the first embodiment in a configuration for conveying a recording medium. In the following description of the second embodiment, the same reference signs will be assigned to the constituent elements similar to those of the first embodiment, descriptions thereof is omitted, and only characteristic constituent elements according to the second embodiment will be described.

In the first embodiment, the recording apparatus 1 is configured based on the presumption that a continuous sheet extending from the unwinding roll portion 2 to the winding roll portion 16 is conveyed. On the other hand, in the second embodiment, the recording apparatus 1 is configured such that standard-sized paper Sb can be conveyed. The recording apparatus 1 has a nip conveyance configuration, and the standard-sized paper Sb is conveyed while being sandwiched by a plurality of pairs of rollers.

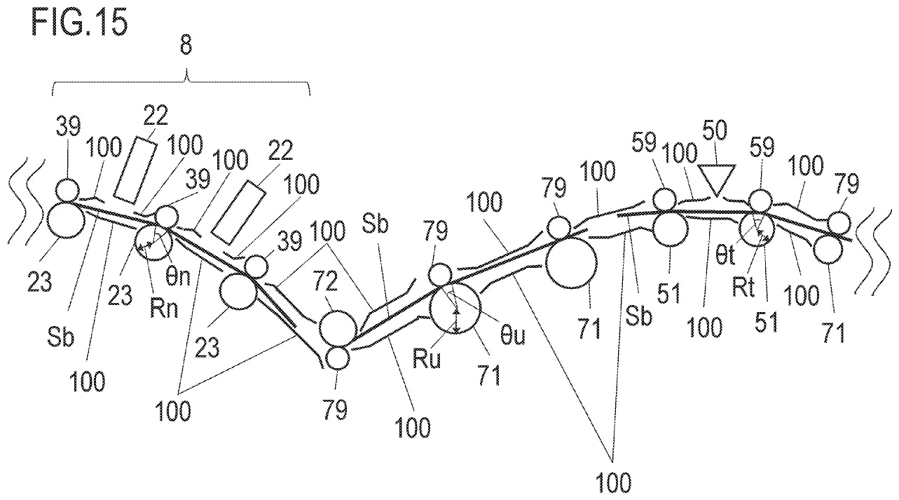

FIG. 15 shows the conveyance path P from the detection portion 7 to the recording portion 8 according to the second embodiment. Motors (not illustrated) are connected to the guide rollers 23, 51, 71, and 72, and the guide rollers are driven by the motors. In addition, the recording apparatus 1 is provided with rubber rollers 39 opposing the guide rollers 23, rubber rollers 59 opposing the guide rollers 51, and rubber rollers 79 opposing the guide rollers 71 and 72. Furthermore, a guide member 100 for guiding the standard-sized paper Sb is provided between two adjacent rollers in the conveying direction. That is to say, in the second embodiment, a conveyance path for the standard-sized paper Sb is constituted by a plurality of pairs of rollers and the guide members 100. Moreover, the rollers are disposed such that the standard-sized paper Sb is constantly supported by three pairs of rollers and the orientation thereof is corrected.

In the second embodiment, the guide rollers 51, 71, 72, and 23 are arranged so as to suppress label peeling of the standard-sized paper Sb that is being conveyed, after the standard-sized paper Sb moves through the floating detection unit 50 until the standard-sized paper Sb enters the recording portion 8, the standard-sized paper Sb having a base material layer subjected to half-cut processing or waste removing processing. Specifically, the sizes and arrangement configurations of the guide rollers 51, 71, 72, and 23 according to the second embodiment are similar to those of the first embodiment. That is to say, the guide rollers are arranged such that the camber Wu of the standard-sized paper Sb that lies along the guide rollers 71 is smaller than the camber Wt of the standard-sized paper Sb that lies along the guide rollers 51.

Accordingly, according to the second embodiment, it is possible to detect label peeling of the standard-sized paper Sb, and to suppress label peeling after the standard-sized paper Sb moves through the detection portion 7 until the standard-sized paper Sb enters the recording portion 8, and thus it is possible to suppress damage to the recording heads 22.

### OTHER EMBODIMENTS

In the above embodiments, the recording portion 8 includes a plurality of recording heads 22, but the present invention is also applicable to a recording apparatus that includes only one recording head 22. In addition, for applying the present invention, a recording head does not need to be a full-line head, and a recording apparatus may be a serial recording apparatus in which a recording head discharges ink and forms an image while a carriage equipped with the recording head is moving in the paper width direction.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-011019, filed on Jan. 27, 2023, which is hereby incorporated by reference herein in its entirety.

What is claimed is:

1. A recording apparatus comprising:
a first rotating member for supporting a recording medium while rotating, and conveying the recording medium along an outer peripheral surface of the first rotating member such that a recording side of the recording medium bulges;
a second rotating member that is adjacent to and downstream of the first rotating member in a conveying direction of the recording medium, the second rotating member being for supporting the recording medium while rotating;
a third rotating member downstream of the second rotating member in the conveying direction, the third rotating member being for supporting the recording medium while rotating, and conveying the recording medium along an outer peripheral surface of the third rotating member such that the recording side of the recording medium bulges;
a recording portion for performing a recording operation on the recording side of the recording medium, at a location downstream of the third rotating member in the conveying direction; and
a floating detection portion for detecting floating of the recording medium between the first rotating member and the second rotating member,
wherein, as viewed along a rotation axis line direction of the first rotating member, letting a first arc portion be an abutment portion between the recording medium and the first rotating member, and letting a third arc portion be an abutment portion between the recording medium and the third rotating member, a third arc height, which is a distance from a chord of the third arc portion to an apex of the third arc portion, is smaller than a first arc height, which is a distance from a chord of the first arc portion to an apex of the first arc portion.

2. The recording apparatus according to claim 1, wherein
the second rotating member conveys the recording medium along an outer peripheral surface of the second rotating member such that the recording side of the recording medium bulges, and
as viewed along the rotation axis line direction, letting a second arc portion be an abutment portion between the recording medium and the second rotating member, a second arc height, which is a distance from a chord of the second arc portion to an apex of the second arc portion, is smaller than or equal to the first arc height.

3. The recording apparatus according to claim 1, wherein
the recording medium is a label roll constituted by a base material layer that has the recording side, a release layer, and an adhesive layer for adhering the base material layer and the release layer to each other, and
letting Y be a thickness of the release layer of the recording medium, letting Rt be a radius of the first rotating member, letting θt be a central angle of the first arc portion, letting Ru be a radius of the third rotating member, and letting θu be a central angle of the third arc portion,
the first rotating member and the third rotating member satisfy:
$$( Ru + Y ) \{ 1 - cos ( θ u / 2 ) \} < ( Rt + Y ) \{ 1 - cos ( θ t / 2 ) \} . \qquad Expression 1$$

4. The recording apparatus according to claim 1, wherein
a central angle of the third arc portion is smaller than a central angle of the first arc portion.

5. The recording apparatus according to claim 2, further comprising:
a fourth rotating member downstream of the third rotating member in the conveying direction, the fourth rotating member being for supporting the recording medium while rotating, and conveying the recording medium along an outer peripheral surface of the fourth rotating member such that the recording side of the recording medium bulges; and
a fifth rotating member that is adjacent to and downstream of the fourth rotating member in the conveying direction, the fifth rotating member being for supporting the recording medium while rotating,
wherein the recording portion includes a discharging head for discharging a liquid toward the recording side of the recording medium, at a location between the fourth rotating member and the fifth rotating member in the conveying direction, and
as viewed along the rotation axis line direction, letting a fourth arc portion be an abutment portion between the recording medium and the fourth rotating member, the first arc height is equivalent to a fourth arc height, which is a distance from a chord of the fourth arc portion to an apex of the fourth arc portion.

6. The recording apparatus according to claim 5, wherein
a distance between the first rotating member and the second rotating member is equivalent to a distance between the fourth rotating member and the fifth rotating member, a radius of the first rotating member is equivalent to a radius of the fourth rotating member, a radius of the second rotating member is equivalent to a radius of the fifth rotating member, and a central angle of the first arc portion is equivalent to a central angle of the fourth arc portion,
the second rotating member conveys the recording medium along the outer peripheral surface thereof such that the recording side of the recording medium bulges,
the fifth rotating member conveys the recording medium along an outer peripheral surface thereof such that the recording side of the recording medium bulges, and
as viewed along the rotation axis line direction, letting a fifth arc portion be an abutment portion between the recording medium and the fifth rotating member, a central angle of the second arc portion is equivalent to a central angle of the fifth arc portion.

7. The recording apparatus according to claim 1, further comprising:
a sixth rotating member downstream of the third rotating member and upstream of the recording portion in the conveying direction, the sixth rotating member being for supporting the recording medium while rotating, and conveying the recording medium along an outer peripheral surface of the sixth rotating member such that a side of the recording medium opposite to the recording side thereof bulges.

8. The recording apparatus according to claim 7, wherein
as viewed along the rotation axis line direction, letting a sixth arc portion be an abutment portion between the recording medium and the sixth rotating member, a central angle of the sixth arc portion is larger than a central angle of the first arc portion and a central angle of the third arc portion.

9. The recording apparatus according to claim 1, wherein
the floating detection portion detects an amount of floating of the recording medium from a conveyance path that extends between the first rotating member and the second rotating member.

10. The recording apparatus according to claim 1, further comprising:
a plurality of rotating members that respectively oppose the first rotating member, the second rotating member, and the third rotating member, so as to sandwich and convey the recording medium.

11. A recording apparatus comprising:
a first rotating member for supporting a recording medium while rotating, and conveying the recording medium along an outer peripheral surface of the first rotating member such that a recording side of the recording medium bulges;
a second rotating member that is adjacent to and downstream of the first rotating member in a conveying direction of the recording medium, the second rotating member being for supporting the recording medium while rotating;
a third rotating member downstream of the second rotating member in the conveying direction, the third rotating member being for supporting the recording medium while rotating, and conveying the recording medium along an outer peripheral surface of the third rotating member such that the recording side of the recording medium bulges;
a recording portion for performing a recording operation on the recording side of the recording medium, at a location downstream of the third rotating member in the conveying direction; and
a floating detection portion for detecting floating of the recording medium between the first rotating member and the second rotating member,
wherein, as viewed along a rotation axis line direction of the first rotating member, letting a first arc portion be an abutment portion between the recording medium and the first rotating member, and letting a third arc portion be an abutment portion between the recording medium and the third rotating member, a central angle of the third arc portion is smaller than a central angle of the first arc portion.

12. The recording apparatus according to claim 11, wherein
the second rotating member conveys the recording medium along an outer peripheral surface of the second rotating member such that the recording side of the recording medium bulges, and
as viewed along the rotation axis line direction, letting a second arc portion be an abutment portion between the recording medium and the second rotating member, a central angle of the second arc portion is smaller than or equal to the central angle of the first arc portion.

13. The recording apparatus according to claim 11, further comprising:
a fourth rotating member downstream of the third rotating member in the conveying direction, the fourth rotating member being for supporting the recording medium while rotating, and conveying the recording medium along an outer peripheral surface of the fourth rotating member such that the recording side of the recording medium bulges; and
a fifth rotating member that is adjacent to and downstream of the fourth rotating member in the conveying direction, the fifth rotating member being for supporting the recording medium while rotating,
wherein the recording portion includes a discharging head for discharging a liquid toward the recording side of the recording medium between the fourth rotating member and the fifth rotating member in the conveying direction, and
as viewed along the rotation axis line direction, letting a fourth arc portion be an abutment portion between the recording medium and the fourth rotating member, the central angle of the first arc portion is equivalent to a central angle of the fourth arc portion.

14. The recording apparatus according to claim 13, wherein
the second rotating member conveys the recording medium along the outer peripheral surface thereof such that the recording side of the recording medium bulges,
the fifth rotating member conveys the recording medium along an outer peripheral surface thereof such that the recording side of the recording medium bulges, and
as viewed along the rotation axis line direction, letting a second arc portion be an abutment portion between the recording medium and the second rotating member, and letting a fifth arc portion be an abutment portion between the recording medium and the fifth rotating member, a central angle of the second arc portion is equivalent to a central angle of the fifth arc portion.
